(19) United States
(12) Patent Application Publication
(10) Pub. No.: US 2015/0149201 A1
(43) Pub. Date: May 28, 2015

(54) SYSTEM AND METHOD FOR REMOTE ENCOUNTER AND STATUS ASSESSMENT USING PARALLEL DATA AND VOICE COMMUNICATION PATHS

(71) Applicant: National University of Singapore, Singapore (SG)

(72) Inventors: Charles Franklin Starmer, JR., Singapore (SG); Mohamad Hirwan Bin Mohamed Salleh, Singapore (SG); K Ranga Rama Krishnan, Singapore (SG)

(21) Appl. No.: 14/575,262

(22) Filed: Dec. 18, 2014

Related U.S. Application Data
(63) Continuation of application No. PCT/SG2013/000254, filed on Jun. 19, 2013.
(60) Provisional application No. 61/661,650, filed on Jun. 19, 2012.

(51) Int. Cl. G06F 19/00; H04W 8/24

(52) U.S. Cl. CPC G06F 19/3418; G06F 19/3431; H04W 8/24
USPC 705/2

(57) ABSTRACT

A system and method for providing remote encounter and status assessment, such as a health care encounter for remote patients is provided. The system includes a patient's mobile device and a health care provider's mobile device, both coupled to a network for providing voice and data transfer therebetween. A body parameter measuring device is coupleable to the patient's mobile device and capable of generating data in response to measuring one or more body parameters. The method includes coupling the body parameter measuring device to the patient's mobile device and establishing a voice communication path with the health care provider's mobile device. Concurrently therewith, the patient's mobile device establishes a data communication path with the health care provider's mobile device to provide the data from the body parameter measuring device to the health care provider's mobile device.

### PRIORITY CLAIM

The present application is a continuation of International Patent App. No. PCT/SG2013/000254 filed on 19 Jun. 2013, which claims priority to U.S. Provisional Patent Application No. 61/661,650, filed 19 Jun. 2012, each of which is incorporated herein by reference in its entirety.

### FIELD OF THE INVENTION

The present invention generally relates to radio frequency communications, and more particularly relates to a system and methods for remotely conducting and guiding encounters, monitorings and/or reviews, such as those between a patient and health care provider, using parallel data and voice communication paths for real time information exchange.

### BACKGROUND OF THE DISCLOSURE

A typical encounter between a patient and doctor or other health care provider involves capturing relevant information from two sources: sensing and measuring body parameters such as pulse, weight, heartbeat and breathing; and a concurrent conversation between the patient and the health care provider to obtain a description of the patient's complaints. A medical diagnosis and treatment plan are formed from a review of both sources of information.

Such medical encounters conventionally require a face-to-face visit, as an accurate diagnosis can only be formed from contemporaneously receiving the two sources of information. Also, the conversation preferably involves a two-way discussion where the health care provider obtains information from the patient and asks additional questions based upon that information. In the case of doctors, these encounters require patients to come to the doctor's office or other designated site (e.g., medical clinic) or the doctor or other health provider to visit the patient (e.g., at a hospital or at a home). Such visits are problematic, particularly where the patient needs constant monitoring and, perhaps, modifications to treatment and/or medication in response to that constant monitoring and/or where the patient is bed-ridden. In addition improved decisions can be made if physiological and pathological data is obtained in addition to the history as presented by the patient.

To overcome these issues, body parameters may be measured by one health care provider and later reviewed by the doctor or another health care provider. However, the benefits of contemporaneous review of the patient's parameters and conversation to determine the patient's current health situation are sacrificed for the convenience of visiting the patient remotely. This may result in providing care modification too late to be effective.

Thus, what is needed is a health care system and method which allows remote monitoring and virtual yet physical encounters while maintaining the information exchange of current encounters through both physiological and pathological body parameter measurement and two-way conversation. Furthermore, other desirable features and characteristics will become apparent from the subsequent detailed description, taken in conjunction with the accompanying drawings and this background of the disclosure.

### SUMMARY

According to the Detailed Description, a method for remote patient health assessment is provided. The method includes coupling a body parameter measuring device to a patient's mobile device. The method further includes establishing a voice communication path with a health care provider's mobile device from the patient's mobile device and concurrently establishing a data communication path with the health care provider's mobile device to provide data transport from the body parameter measuring device to the health care provider's mobile device.

In accordance with another aspect, a system for providing health care to remote patients is provided. The system includes a network for providing voice communications and data communications, a patient's mobile device coupled to the network, a health care provider's mobile device also coupled to the network, and a body parameter measuring device. The body parameter measuring device is coupleable to the patient's mobile device and capable of generating data in response to measuring one or more body parameters. The patient's mobile device establishes a voice communication path and a data communication path concurrently across the network with the health care provider's mobile device to provide data transport from the body parameter measuring device to the health care provider's mobile device during voice communication between the patient's mobile device and the health care provider's mobile device.

And in accordance with another aspect, a method for robust communication for status assessment is provided. The method includes coupling a parameter measuring device to a first mobile communication device, establishing a voice communication path between the first mobile communication device and a second mobile communication device, and concurrently establishing a data communication path between the first mobile communication device and the second mobile communication device to provide real-time data transport from the parameter measuring device to the second mobile communication device during voice communication therebetween.

And in accordance with yet another aspect, a method for remote assessment and monitoring is provided. The method includes coupling a parameter measuring device to a mobile device, then establishing a voice communication path with a central monitoring system from the remote mobile device. The method further includes establishing a data communication path with the central monitoring system concurrently with establishing the voice communication path with the central monitoring system to provide data transport from the parameter measuring device to a health care provider's mobile device via the central monitoring system.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to illustrate various embodiments and to explain various principles and advantages in accordance with a present embodiment.

FIG. 1, comprising FIGS. 1A and 1B, illustrates an overview of a mobile medicine system in accordance with a present embodiment, wherein FIG. IA illustrates an overview of the system and FIG. 1B illustrates a feedback loop aspect of the system.

FIG. 2 illustrates a toolbox of Bluetooth enabled devices for use with the mobile medicine system of FIG. 1 in accordance with the present embodiment.

FIG. 3, comprising FIGS. 3A and 3B, illustrates a blood pressure setup for use with the system of FIG. 1 in accordance with the present embodiment, wherein FIG. 3A illustrates a blood pressure cuff, a Bluetooth blood pressure measurement device and a communication device for the setup and FIG. 3B depicts a GSM modem for the setup.

FIG. 4, comprising FIGS. 4A and 4B, depicts screen shots on the communication device of FIG. 3A when operating in the system of FIG. 1 in accordance with the present embodiment, wherein FIG. 4A depicts a screen with an unopened folder having applications for use with the system and FIG. 4B depicts a screen with an opened folder having applications for use with the system.

FIG. 5 illustrates the Bluetooth blood pressure measurement device and the communication device of FIG. 3A in operation in the system of FIG. 1 in accordance with the present embodiment.

FIG. 6, comprising FIGS. 6A and 6B, illustrates acquired patient blood pressure values as presented to the health provider in the system of FIG. 1 in accordance with the present embodiment, wherein FIG. 6A depicts visualization of a received blood pressure value and FIG. 6B depicts a graph of blood pressure values received from the patient over time.

FIG. 7 illustrates an oximeter setup for use with the system of FIG. 1 in accordance with the present embodiment.

FIG. 8 illustrates an oximeter Bluetooth device in the setup of FIG. 7 and a signal being sent and received in the system of FIG. 1 in accordance with the present embodiment.

FIG. 9, comprising FIGS. 9A and 9B, illustrates a reminder setup for a healthcare provider in the system of FIG. 1 in accordance with the present embodiment, wherein FIG. 9A depicts an order entry screen and FIG. 9B depicts possible healthcare reminder choices for the order entry screen of FIG. 9A.

FIG. 10 illustrates a weighing setup for use with the system of FIG. 1 in accordance with the present embodiment.

FIG. 11, comprising FIGS. 11A, 11B and 11C, illustrates acquired patient weight values as presented to the health provider in the system of FIG. 1 in accordance with the present embodiment, wherein FIG. 11A depicts visualization of a received weight value, FIG. 11B depicts a graph of weight values received from the patient over time, and FIG. 11C depicts a table with exemplary problem areas that could be addressed.

FIG. 12, comprising FIGS. 12A, 12B and 12C, illustrates communication device screen shots when a communication device is sending remotely triggering messages in the system of FIG. 1 in accordance with the present embodiment, wherein FIG. 12A depicts a first screen of an application showing a selection of remote triggering messages to send and FIGS. 12B and 12C depict two examples of remote triggering messages to send when selection is made from the first screen as shown in FIG. 12A.

FIG. 13, comprising FIGS. 13A and 13B, illustrates communication device screen shots when a communication device is receiving remotely triggering messages in the system of FIG. 1 in accordance with the present embodiment, wherein FIG. 13A depicts a screen shot appearing when the message is received and FIG. 13B depicts a screen shot when the message is answered.

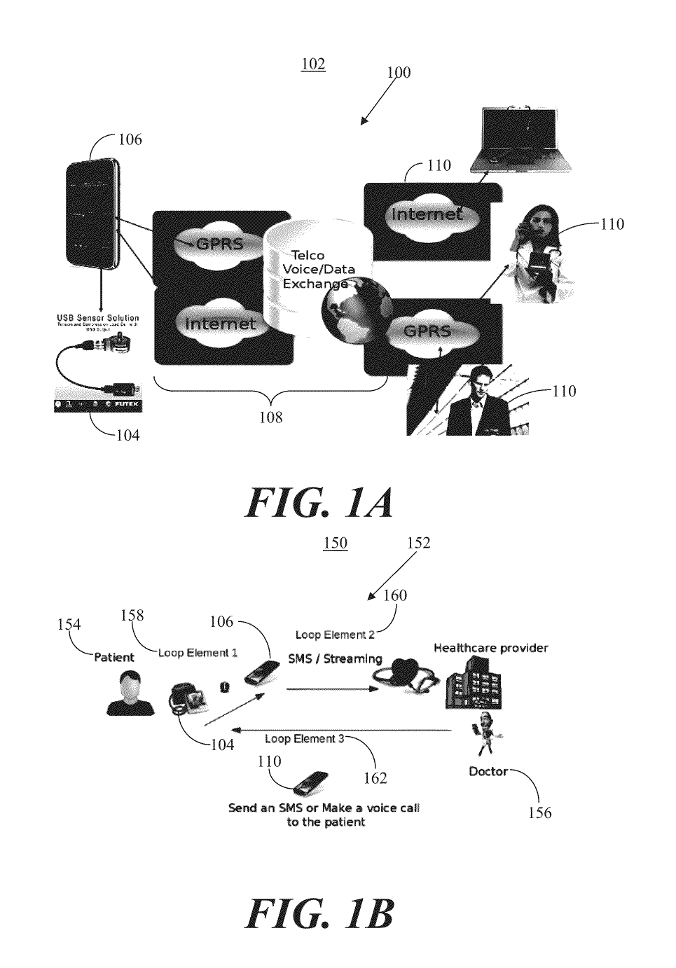

And FIG. 14 illustrates a screen shot from a mobile medicine manager program operating in the system of FIG. 1 in accordance with the present embodiment.

Skilled artisans will appreciate that elements in the figures are illustrated for simplicity and clarity and have not necessarily been depicted to scale. For example, the dimensions of some of the elements in the block diagrams or flowcharts may be exaggerated in respect to other elements to help to improve understanding of the present embodiments.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description of the invention.

Remote consultation and monitoring between patients and medical care givers and between field workers and office/medical center personnel has been quite limited. Such remote consultation typically requires special devices for data capture, special communication resources and often requires parties to be located in specially prepared teleconference facilities. The present system overcomes these drawbacks of the prior art by utilizing the pervasive mobile phone and WiFi networks for parallel voice and data communication. Coupled with the parallel voice and data channels embedded within mobile phone technology, two party (or one party and server) voice and data conversations are independent of the physical location of either party, thereby enabling more pervasive remote consultations in accordance with the present embodiment.

Systems and methods in accordance with the present embodiment are useful for health care worker in-hospital monitoring of suitably instrumented parties, for home medical monitoring—with data flowing between patient homes and a central monitoring facility, for distant patient monitoring, for example between a hospital in one location with consultations in a distant location, for remote monitoring of the status of field equipment and communicating the status back to the home office, for consultation between field workers and home office experts, and for remote consultations between patients and health care professionals. Within health care facilities, the present embodiment also enables health care workers to monitor patient status when not co-located with the patient.

Referring to FIG. 1, including FIGS. 1A and 1B, an overview of a mobile medicine system 100 in accordance with a present embodiment is illustrated. FIG. 1A is a diagram 102 which depicts the mobile medicine system 100 and the data flow of information within the system 100. Data flows from a transducer or sensor 104 attached by a USB cable or Bluetooth communication to a communication device 106 such as a cellular phone and thence to a Telco/Internet backbone 108. From the Telco/Internet backbone 108, the data will then flow to a target communication device 110 such as a mobile phone or a server.

Thus, data is acquired from a transducer/sensor 104 connected to a mobile phone 106. This transducer/sensor 104 could be coupled to a weighing machine or could be an oximeter for blood oxygen level detection. Any other diagnostic equipment capable of capturing patient data and transmitting it via a USB cable or Bluetooth to the mobile phone 106 could also be used. Using a software application of the mobile phone 106, a user can enter a phone number of a desired party (e.g., a healthcare provider or a health monitoring service). The application then discovers the Internet address of the desired party (an IP discovery step) in a manner well-known to those skilled in the art. The application also initiates a voice call and triggers an appropriate application on the called party's phone 110. Upon answering the call, the called party is in voice communication with the calling party and can simultaneously view the data being acquired by the calling party via the transducer 104. The voice/data connection is maintained for the duration of the consultation between the calling party and the called party.

Those skilled in the art will realize that the system depicted in FIG. 1A advantageously extends the doctor-patient encounter beyond the physical location of conventional face-to-face doctor-patient encounters. The mobile phone 106 (or other mobile device such as a tablet) operating in conjunction with networks 108 such as telephone networks and/or WiFi networks remove the constraints on the location of doctor and patient and provide paths for simultaneous voice and data communication. The system 100 includes methods, protocols and tools (a) for acquiring data from sensors on the patient or adjacent to the patient, (b) for locating, identifying and triggering communications with a mobile phone 110 or other suitable mobile device or fixed device belonging to the health care provider or system, (c) for triggering applications on the patient's phone 106 or the health care provider's phone 110, and (d) for transport of real time data between the health care provider's phone 110 and the patient's phone 106 while maintaining constant voice communication between two or more parties.

Voice communication and data capture/data transport to another party is central to many enterprises that have devices and/or patients located away from experts/doctors. Modern mobile devices such as smart phones and tablet computers with access to a telephone network or the Internet provide both voice and data circuits, thus positioning them as potential endpoints for linking remote monitoring and consultation between field workers and hospital-based or office-based health care workers or their assistants. Mobile technology also provides an interface for capturing data using any of an array of available signal transducers 104 (e.g., blood pressure, electrical signals such as EEG and ECG, optical signals such as oximetry and ophthalmoscopic images, ultrasound signals, reaction time monitors), as well as a platform for both data analysis and establishing a connection with another individual, entity or server with the ability to concurrently talk with the other party/server while transporting data acquired from the attached transducer such as by transferring data or episodic messaging of data. The data transport could be accomplished by streaming via User Datagram Protocol (UDP), transferring data packets via Transmission Control Protocol (Internet Protocol) (TCP/IP) or episodic text messaging via Short Messaging Service (SMS).

The central concept is that mobile technology coupled with existing telephone networks or internet access closes the feedback loop between the two parties. In the past, data could be acquired but a diagnosis and/or instructions of what to do next was deferred until either a face-to-face encounter or voice communication. Mobile devices using existing networks to establish connectivity with a doctor or clinic enables data acquired by a subject, patient or field worker to be transported in conjunction with a voice commentary/dialog to another entity, expert or colleague, using a smartphone or similar mobile device in accordance with the present embodiment eliminates the need for a face-to-face encounter. A bidirectional data and voice path enables a feedback loop between the parties which can be used to discuss diagnosis and treatment options or request/receive additional patient data.

Referring to FIG. 1B, a diagram 150 depicts an example of a feedback loop 152 in accordance with the present embodiment. In the multi-party feedback loop 152, a remote or home-bound patient 154 who is transferring data to a healthcare provider 156 could provide critical information for deciding whether a clinic visit is required or the transferred data could be used to make treatment recommendations to the patient 154. The patient 154 or other caller enables Loop Element One 158 by coupling the transducer 104 to a patient parameter measuring device and to a communication device 106. A call is initiated to the healthcare provider, an office/clinic/hospital assistant or a server 156, thereby enabling Loop Element Two 160. As described above, the call includes parallel communication paths where voice communication is made over one of the parallel paths of Loop Element Two 160 and patient data is communicated as a SMS message or streamed in real time over another one of the parallel paths of Loop Element Two 160. The healthcare provider 156 receives the patient data and communicates with the caller. In this manner, the healthcare provide can communicate with the caller to initiate, modify or continue treatment of the patient 154 by one or more SMS messages and/or by a voice call, thereby enabling Loop Element Three 162 and completing the feedback loop 152.

In accordance with the present embodiment, the patient 154 is not required to be the caller. For example, within a health care facility, data acquired from patients in a clinic or bedside can be streamed to the appropriate health care provider for assessment and feedback to a bedside nurse or other healthcare provider. In addition, a voice/data dialog can be established between a medical student and a senior or mentoring physician.

Those skilled in the art will also realize that the healthcare provider 156 could also start communication within the feedback loop 152 by sending a SMS message along Loop Element Three 162 to the patient 154 to measure one or more patient parameters and call back when sending the information. For example, the doctor, the assistant, a clinic or a server may provide repeating reminders (for example, via SMS or email from a phone or server) to a patient to perform some activity (e.g. weighing) along Loop Element Three 162. At the time of receiving the reminder, the patient 154 can accept or reject the reminder. If accepted, a related application could be triggered on the patient's mobile device. Results of the activity could be received by the application from a Bluetooth or USB connected device along Loop Element One 158 and forwarded back to the doctor or clinic along Loop Element Two 160. When results are not received within a fixed time limit, the reminder can be repeated along Loop Element Three 162. In this manner, the healthcare provider 156 can obtain regular patient data in order for the healthcare provide 156 to remotely monitor compliance by the patient 154 with recommended treatments and prompt the patient 154 as and when needed.

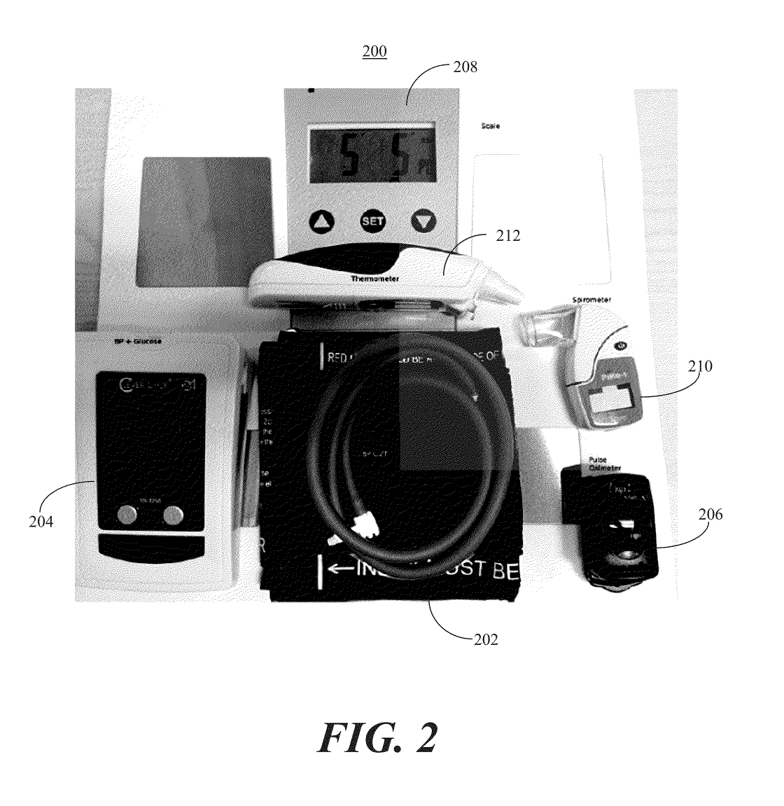

The practicing doctor, health care provider or other medical professional requires many devices to evaluate a patient's status. Referring to FIG. 2, a toolbox 200 of Bluetooth or USB enabled devices for use with the mobile medicine system 100 in accordance with the present embodiment is illustrated. The toolbox 200 includes a blood pressure cuff 202 and a blood pressure Bluetooth monitor 204 which can also be used to measure glucose levels. An oximeter 206 for detecting pulsatile blood flow and oxygen saturation, scales 208 for measuring weight, a spirometer 210 for assessing respiration, and a thermometer 212 for measuring temperature are also shown in the toolbox 200.

All of these are either Bluetooth-enabled or USB coupleable in order to communicate with the patient's communication device 106 (FIG. 1). For example, the blood pressure monitor 204 could be used to monitor hypertension data, which readings are preferably transmitted as SMS messages. Similarly, the pulse oximeter 206 which can be used to measure heart rate can monitor cardiac arrhythmia (heart rate variability) and transfer data along the Loop Element Two 160 (FIG. 1B) by, for example, SMS messages and/or streaming data via 3G cellular communication or WiFi wireless LAN communication. Similarly, other tools could be used to remotely monitor for additional symptoms in accordance with the present embodiment, such as the glucose meter 204 used to monitor diabetes, the weighing scales 208 used to monitor congestive heart failure, or the spirometer 210 used to monitor asthma or chronic obstructive pulmonary disease (COPD), all of which could transfer the readings taken by SMS messaging along Loop Element Two 160 of the system 100.

While not shown in the toolbox 200, other devices such as a stethoscope for listening to sounds from the patient 154, an ultrasound for assessing internal structures of the patient 154, electrical signal measuring devices such as EEG and ECG, and an opthalmoscope for assessing the patient's retina could also be used in accordance with the present embodiment.

The medical professional uses data from these devices and the patient's response to various questions about their present physical state to formulate a diagnosis and determine a current medical state of the patient. In accordance with the present embodiment, this acquisition of data and patient communication can advantageously be extended to a patient irrespective of his/her location or status. Based on a standard data capture process (whether from an on board transducer such as a camera or microphone or an outboard transducer such as an oximeter or spirometer), data is captured as a single object (photographic image from the onboard camera) or as a data stream, and outboard transducer(s) can be coupled either by Bluetooth or USB cable to the communication device 106 for providing the data for transmission from the device 106.

A software application processes, displays the data on the mobile phone display, discovers the called party's Internet Protocol (IP) address, establishes a voice link via the mobile phone voice network and a data link via the mobile phone IP network. Should the called party not be available, the calling party can redirect the call to a server, leaving a voicemail message as well as a data file for later access by the called party or to another party or location that is providing coverage.

In accordance with the present embodiment, the data is encrypted to protect confidentiality of the patient data. Encryption can be controlled by a handshake and key exchange or other encoding/decoding familiar to those skilled in the art which allows for maintaining high security of patient data transferred. In addition, identification of the patient is protected by identifying the patient by a unique identifier of the communication device 106 and/or a unique identifier associated with the USB or Bluetooth enabled patient data measuring device 202, 204, 206, 208, 210, such as a MAC address. This unique identifier is further protected by encrypting it along with the captured data. Thus, the communication device 106 can capture the MAC address of the patient data measuring device 202, 204, 206, 208, 210, embed the MAC address and the measured data into a message, and encrypt the message for SMS transmission. Thus, the data, either encrypted or unencrypted, can be stored in a database in conjunction with other data (also either encrypted or unencrypted) received from that patient so that trends can be mapped, graphed and observed in order to provide a more complete patient history for the health care provider 156. If the data is stored as encrypted data, it is preferably decrypted when the data is accessed by the healthcare provider 156 through a secure and authenticated link, thereby adding another layer of protection for the confidential patient data.

The communication device 106 (e.g., mobile phone), transducers 104, SMS monitoring and triggering application and transducer specific application software represent the system 100 for enabling parallel data and voice transport between two parties. The present embodiment enables the system 100 by supporting interfaces to sensors that are Bluetooth and/or USB enabled and including mobile phones or similar devices including tablets, software applications that capture, analyze and display acquired data on such devices' displays, software applications that discover the IP address of the called party and transports both voice and data over mobile phone network infrastructure to the called party, and applications that provide reminders and trigger applications on remote mobile devices as discussed hereinbelow.

The present embodiment also includes methods implemented to address the above functions. Such methods would include some or all of the following steps:

Triggered Authorization to Initiate a Voice/Data Dialog Between Two Parties.

A background application on the called party's mobile device monitors incoming messages and recognizes commands that will trigger local applications. When the monitor application recognizes an event request, the user is prompted to accept or reject the request for initiating the voice/data dialog between parties.

Acquisition of Data.

A software application establishes a data conversation between a Bluetooth or USB connected transducer, accepts data from the connected device, decodes and organizes the data into a form suitable for analysis/display and forwards the incoming data to a remote device using IP User Datagram Protocol (UDP), Transmission Control Protocol (Internet Protocol) (TCP/IP) packets or SMS for data transport.

Analysis of Data.

A software application performs appropriate analysis of the transducer data stream. For example, the software application calculates heart rate and regularity of heart rhythm from a Bluetooth enabled oximeter. The analysis module can, for example, smooth the incoming data (such as for oximeter data), detect a segment of data associated with a single heart beat (typically recognized as the data between two successive upstrokes at >25% peak to peak values), identify the time interval between two successive upstrokes, and compute the mean, variance and standard deviation for a specific interval of data (e.g., one minute). In addition, the software module could be set with parameters that automatically notify the individual with what he should do and then notify the monitoring personnel when such parameters are met.

Display of Data.

The software application continuously displays acquired data on the mobile phone display of both the calling and called party as well as displaying parameters available from the analysis.

SMS/Internet Monitoring and Triggering.

When the Internet address of the called party is unknown, a SMS is used to provide IP address discovery and triggering of applications on the calling and called party's phone. The called party has a background application running that monitors incoming SMS traffic and searches for action commands. Upon detection of a valid action command, the application executes the command. For example, the application starts another application, reads system information, or replies to the calling party via a SMS with requested information.

Internet Protocol Address Discovery.

The calling party must either know or automatically discover the IP address of the called party in order to stream data to the called party's mobile phone using the mobile phone network data path. An automatic SMS dialog between calling and called party's phone is one example of automatic IP discovery. The calling party initiates a request for the IP address of the called party using the called party's phone number. Optionally, the calling party can include their IP address. Upon receipt of the calling party's request, the called party's SMS monitoring application reads the IP address from the called party's phone information and returns the IP address via an SMS reply to the calling party. Alternatively, a discover dialog can take place via Internet access to a participant directory comprised of phone numbers and email addresses associated with the user's IP address.

Called Phone Application Triggering.

Using an SMS, the calling party can request an application to start on the called party's phone. Upon receipt of an SMS requesting the initiation of a specific application, the called party's SMS monitoring application triggers an application on the called party's phone similar to that used by the calling party, except incoming data is acquired from the calling party's UDP data stream (directed to the called party's IP address) instead of data streaming from the calling party's signal transducer.

Data Streaming, Consultation and Intervention.

After the calling party calls the called party, a voice discussion can take place while the calling party's application discovers the called party's IP address and triggers the appropriate application on the called party's phone to enable the called party to observe the data. Once enabled, the data is encrypted for streaming on the originating device and decrypted for display/analysis on the terminating device. In parallel with data transport, the called and calling parties discuss the data and the calling party's situation. If needed, the called party can trigger applications on the calling party's phone via the SMS monitor in order to capture additional data (for example, GPS data from location services).

Server Intermediary.

Optionally, the calling party can call a server and trigger applications to record a voice message as well as a data file.

Server Data Access and Called Party Notification.

Following the data encryption/decryption and voice message transfer from the calling party to the server, application software on the server can notify appropriate personnel and possibly forward the data to another individual.

Retrieval of Voice and Encrypted Data from the Server.

Software authenticates a user and enables either the called party or an appropriate surrogate to retrieve the voice mail message and access the encrypted data file from the calling party.

Reminder and Feedback Detection.

A reminder is a message sent to a party requesting an action (for example, weighing oneself). Upon receipt of the message, it is displayed and waits for the user to accept and perform or defer the appropriate action. Upon completion of the action, a reply, indicating completion of the action and including data (if appropriate) is sent to the requesting agent (e.g., a server or a health care worker). If the action is not completed within a prescribed time interval, another reminder (either local or from the initiating party) is triggered, and continued periodic reminders are triggered until the action is completed or the user terminates the reminder. Feedback from the called party, either as data from the requested action or termination by the called party, is sent back to the calling party/agent.

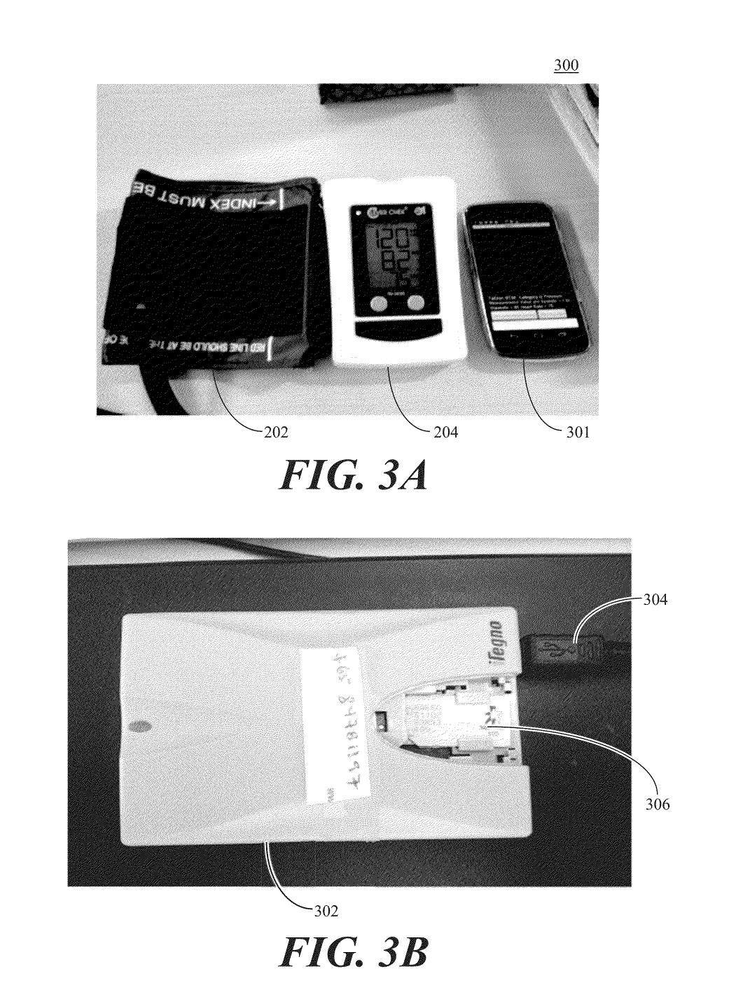

These and other portions of the system 100 will be described in reference to FIGS. 3 to 14 which depict various exemplary usages of the system 100. Referring to FIG. 3, which includes FIGS. 3A and 3B, a blood pressure setup 300 for use with the system 100 in accordance with the present embodiment is illustrated. FIG. 3A illustrates the blood pressure cuff 202, the Bluetooth blood pressure measurement device 204 and a communication device 106 for the setup 300. In the setup 300, the communication device 106 is a smartphone 301 and, in accordance with the present embodiment, the setup 300 operates under the control of a user of the smartphone 301 and an application (or “app”) on the smartphone.

The communication device 106 could also be a computer system connected to a mobile phone modem. Likewise, a computer or server at the healthcare provider 156 side could be connected to a mobile phone modern. FIG. 3B depicts a mobile phone modern 302 for wireless communication from or to the patient 158. The modem 302 is a GSM mobile phone modern and is coupled to a computer via a USB cable 304 and includes a SIM card 306 for registering on a wireless network. The mobile phone modern 302 (with SIM card 306) is connected to a computer, such as a laptop or server, and enables the computer to both accept and initiate SMS transmissions. Those skilled in the art will understand that there exists a number of software packages which could be utilized by the computer to accept and/or initiate SMS messages. An exemplary software package is the open source package, gammu, which can support server/laptop SMS message management.

So, the communication device 106, whether the smartphone 301 or a computer connected to the GSM mobile phone modem 302, is used to provide patient 154 or healthcare provider 156 alerts and trigger remote applications that prompt the patient 154 to take specific actions (e.g., measure blood pressure, weight, or blood glucose level) and return results to a server or computer coupled to a mobile phone modem 302 or another mobile device accessible by the healthcare provider 156.

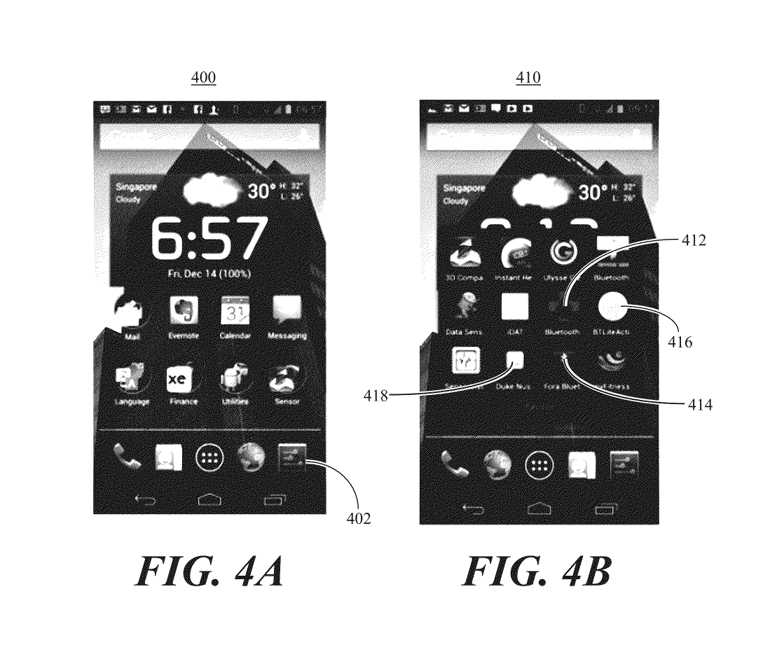

Referring to FIG. 4, including FIGS. 4A and 4B, screen shots on the communication device 301 are depicted when operating in the system 100 in accordance with the present embodiment. FIG. 4A depicts a screen shot 400 with an unopened sensor folder 402 for use by the patient 154. The folder 403 includes applications (or ‘apps’) for use with the system 100 and FIG. 4B depicts a screen shot 410 with the folder 402 opened and illustrating ‘apps’ such as an ‘app’ 412 for Bluetooth oximeter use, an ‘app’ 414 for use with a Bluetooth blood pressure device, an ‘app’ 416 for use with a weighing device and an ‘app’ 418 for SMS triggering.

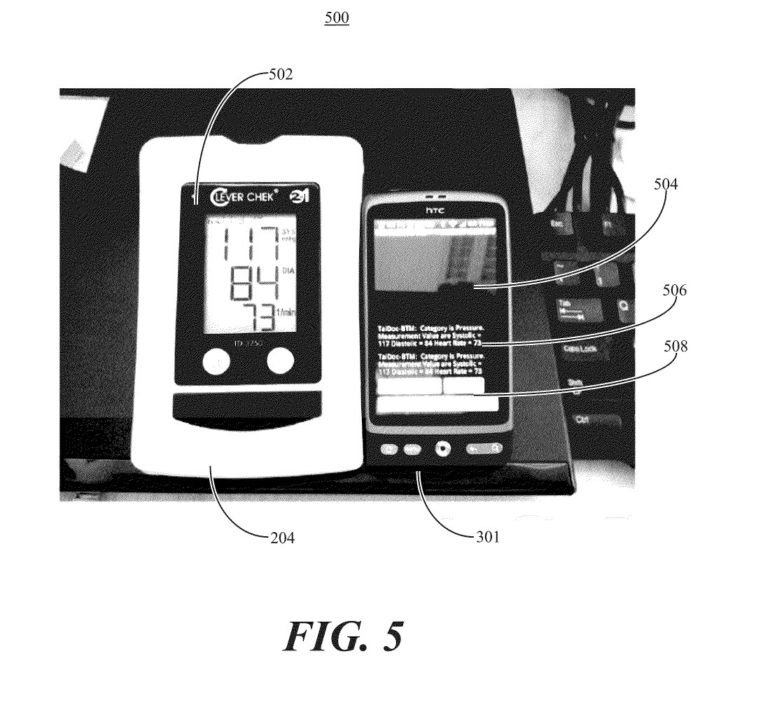

FIG. 5 provides an illustration 500 of the Bluetooth blood pressure measurement device 204 and the smartphone communication device 301 in operation in the system 100 in accordance with the present embodiment. A light 502 in the upper left of the blood pressure measurement device 204 indicates Bluetooth pairing and communication with the smartphone 301. A display 504 of the smartphone 301 shows the measurements 506 acquired from the blood pressure measurement device 204 and information 508 indicating readiness for the measurements 506 to be transferred to a remote phone/server of the healthcare provide 156 via SMS.

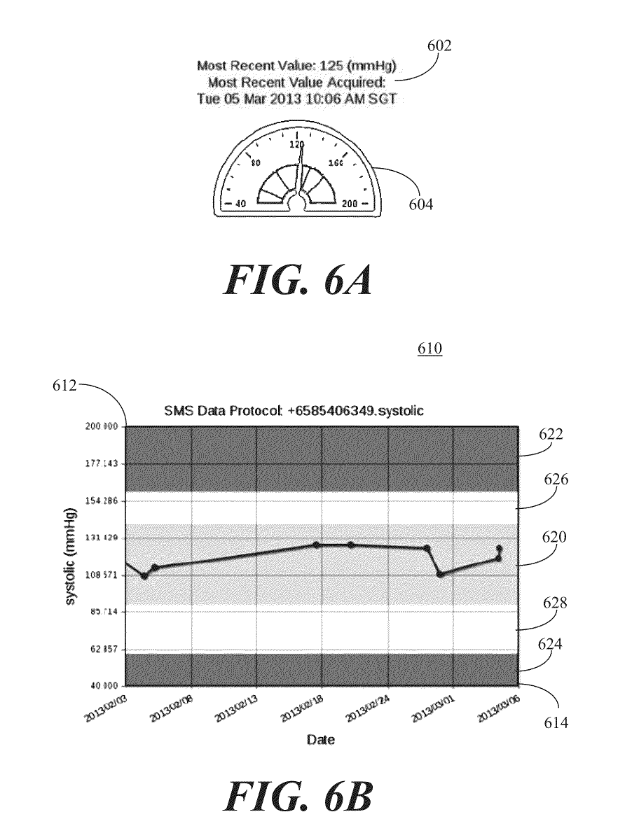

Once data is transmitted from the patient 154 to a computer or a server of the healthcare provider 156, results are available for browser display on mobile devices as well as desktop systems. FIG. 6, comprising FIGS. 6A and 6B, illustrates acquired patient blood pressure values as displayed to the health provider 156 in accordance with the present embodiment. Referring to FIG. 6A, information 602 regarding the received blood pressure value is displayed along with a graphic 604 depicting a visualization of the received blood pressure value. FIG. 6B depicts a graph 610 of blood pressure values along the y-axis 612 received from the patient 156 over time plotted along the x-axis 614. An acceptable blood pressure band 620 in the middle highlights blood pressure values that are considered normal. An upper unacceptable blood pressure area 622 and a lower unacceptable blood pressure area 624 highlight blood pressure values outside the normal range. And upper and lower transition bands 626, 628 highlight blood pressure values of concern. Presenting the blood pressure values in this manner allows the healthcare provider 156 to quickly view trends in the blood pressure of the patient 154 and treat it accordingly. The healthcare provider 156 can also quickly tell whether his instructions to the patient 154 are having the correct effect.

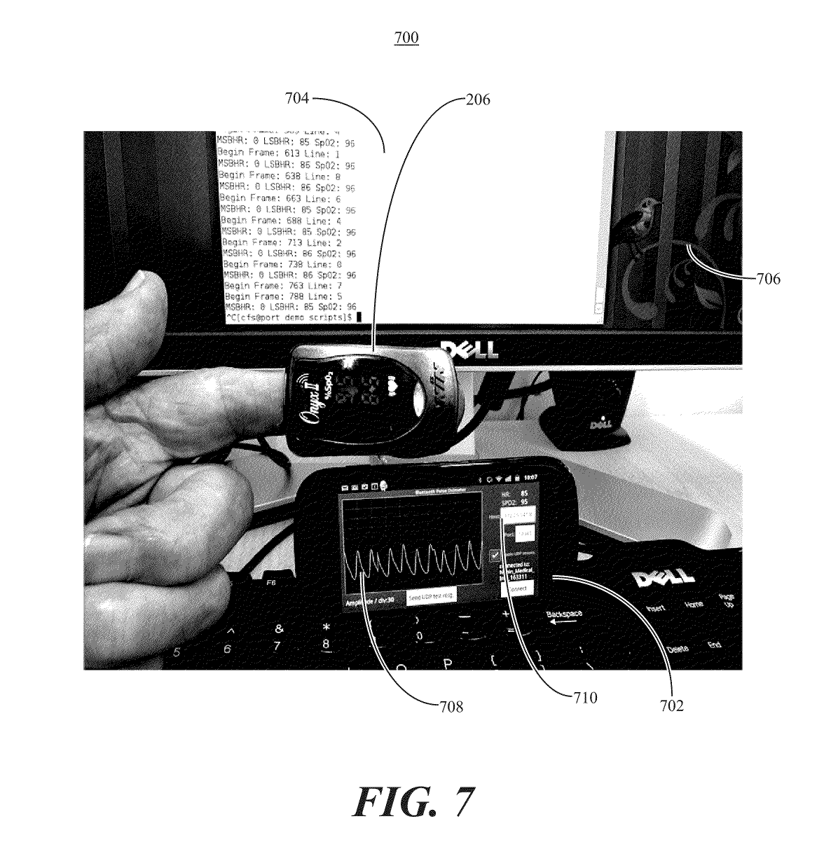

FIG. 7 illustrates an oximeter setup 700 for use with the system 100 in accordance with the present embodiment. The Bluetooth oximeter transducer 206 is coupled to a finger of the patient 154. The oximeter 206 produces streaming data showing pulse (heart rate) as well as data on oxygen content of the patient's blood. The data measured by the oximeter 206 is forwarded as streaming data by either 3G cellular communication signals (via the wireless modem 302) or WiFi local area network signals to a cellular phone 702. A display 704 of a desktop computer 706 shows a log of the streaming data. A display 708 of the cellular phone 702 shows a visual representation of the pulse signal along with blood oxygen readings. The cellular phone 702 then forwards the data across a data communication path to an internet backbone of a cellular network, with the IP address of the computer 706 displayed at portion 710 of the cellular phone display 708.

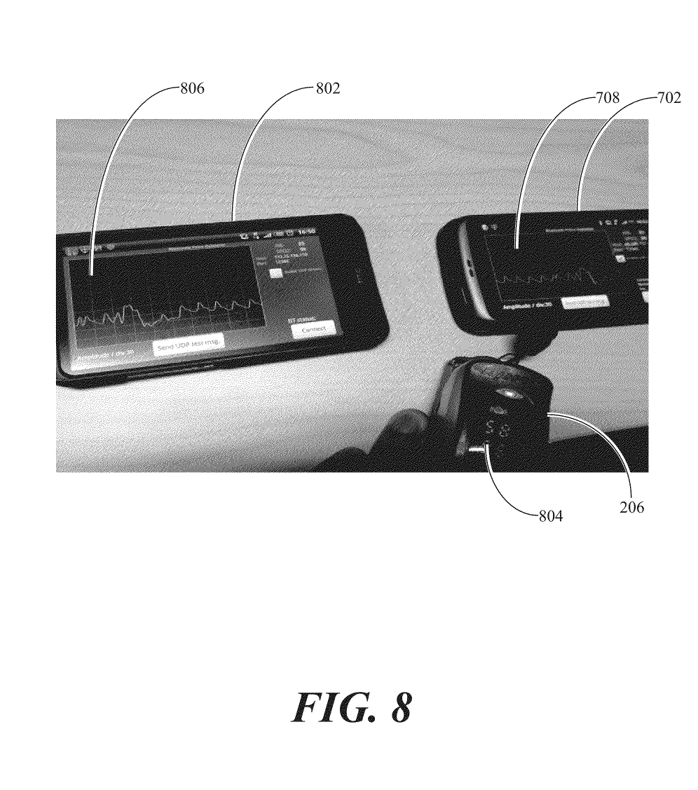

FIG. 8 illustrates the Bluetooth oximeter device 206 with a signal being sent from the cellular phone 702 and received by a second communication device (a cellular phone 802) in accordance with the present embodiment. Data flows from the oximeter device 206 (via Bluetooth signaling) to the cellular phone 702. The oximeter device 206 also shows static data on its display 806, such as pulse rate and blood oxygen value. An application (i.e., ‘app’) in the cellular phone 702 displays the data from the oximeter device 206 on the display 708 and streams the data to the second cellular phone 802. An application in the cellular phone 802 displays on its display both the continuous, streaming data received thereby, as well as discrete data such as heart rate and measured oxygen saturation.

In accordance with this system and the steps identified above, one or more methods for remote patient health assessment can be enabled. An exemplary method begins with a patient or subject 154, as a calling party, activating an application on the calling party's mobile device 702 (e.g., cellular phone/tablet) and coupling a transducer (e.g., a Bluetooth oximeter 206) to the mobile device 702. The calling party then selects or enters a phone number of a health care provider 156 (e.g., a doctor, a nurse, a specialist or a server) and initiates a transaction with that called party. The called party authorizes the activation of an application and returns a request for information. The calling party's application initiates an IP address discovery process (by, for example, sending a discovery SMS to the called party's mobile device 802). Next, the called party's mobile device 802 sends its IP address to the calling party's mobile device 702 and activates a receiver application on the called party's mobile device to accept data from, for example, an incoming UDP/TCP data stream across an internet data communication path established with the exchange of the IP addresses.

Data acquisition is then initiated on the calling party's mobile device 702, and a voice communication path is initiated to the called device. When the called device is a health care provider's mobile device 802, the health care provider 156 accepts the call and talks with the subject 154 while viewing the data. If, on the other hand, the called device is a server, the calling party 154 leaves a voice mail message on the server while the server is recording the incoming UDP or TCP/IP stream of data. When appropriate, the phone connection is terminated. Upon termination, if the called party is a server, the server initiates an SMS to an expert (e.g., a health care professional) in the directory of available experts indicating a data file and voice mail are available for consultation.

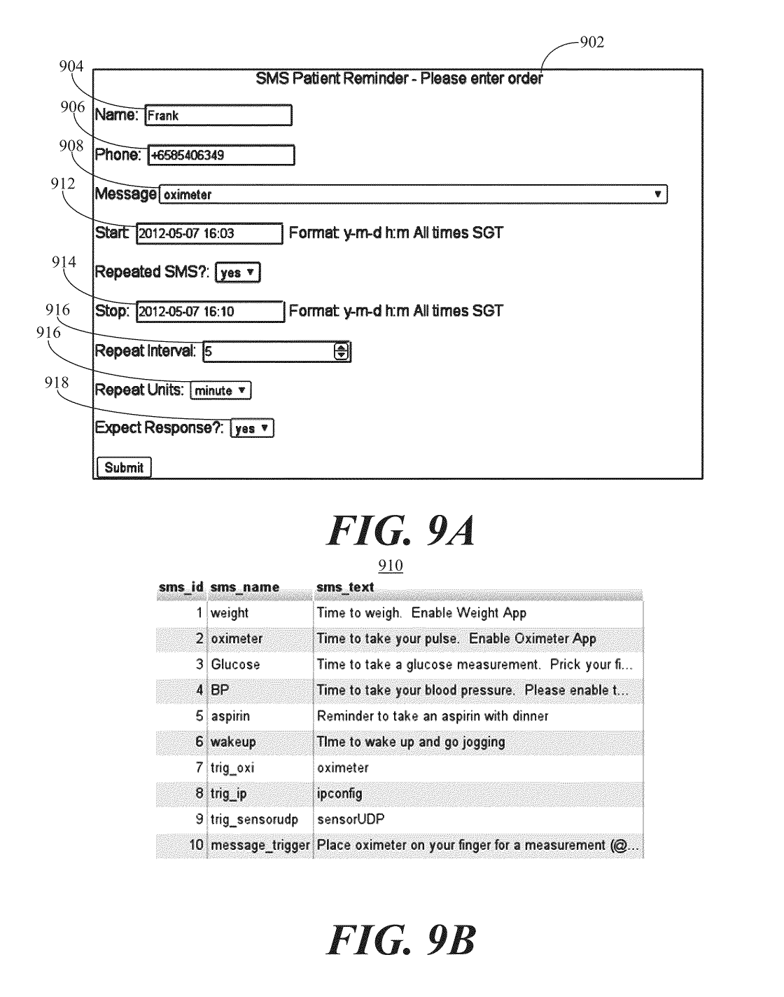

Referring to FIG. 9, including FIGS. 9A and 9B, a patient reminder system is depicted. FIG. 9A depicts a screenshot 902 of an entry screen for the system 100. In accordance with the present embodiment, the system 100 allows a patient to be identified by name 904 and mobile device number 906. The reminder message would be a standard reminder message selected from a pull-down menu 908. Several standard reminder messages are shown in a table 910 of FIG. 9B and these messages could be loaded from the pull-down menu 908. A start time 912 and a stop time 914 for the reminder is entered as well as a repeat interval 916. If a repeated SMS is selected 918, the reminder will be sent once every specified time interval until a response is received if selection 918 indicates a response is expected. In this manner, the health care professional 156 can monitor weight gain or blood sugar level remotely by reminding the patient 154 to take these measurements. For bed-ridden patients or stay home patients, this would allow a public health nurse to service more patients by obtaining body parameter information on a regular basis without the need to physically visit the person.

By way of explanation, an event sequence for establishing end-to-end communication between the patient 154 and the health care professional 156 in the feedback reminder system 150 utilizing the reminder system of FIG. 9 in accordance with the present embodiment is described. A server or mobile device reminder application is triggered at a prescribed time in response to inputted information (e.g., FIG. 9A). The server sends a reminder message to a patient's mobile device at the appointed time. The mobile device receives the reminder and triggers an appropriate application, such as a data acquisition application to accept data from a connected device, such as the weight transducer 208. The patient completes the reminder process and data is returned to the reminding party or appropriate server. If no data is received from the patient after a prescribed time, another reminder is initiated and sent to the patient.

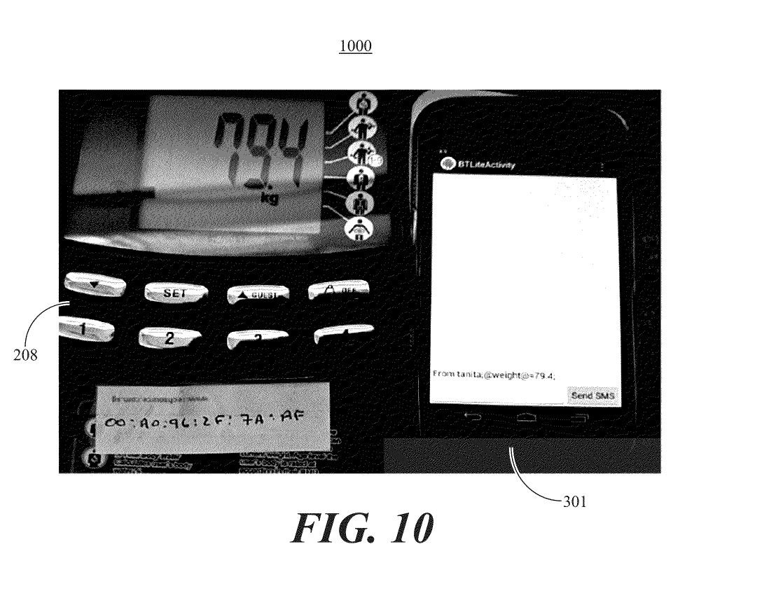

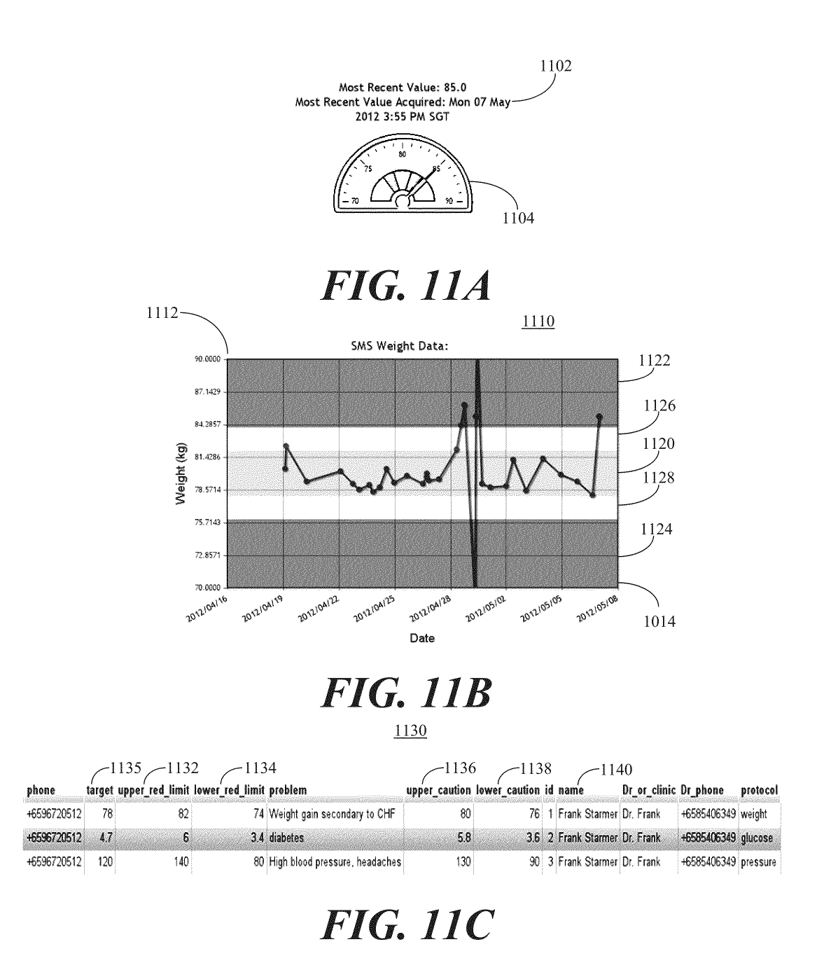

FIG. 10 illustrates a weighing setup 1000 for use with the system 100 in accordance with the present embodiment. The weighing scales 208 are Bluetooth coupled to the cellular telephone 301 for sending episodic messaging data of a measured weight of the patient 154 as an SMS message in a manner similar to the method described above. Also, similar to the manner described above, FIG. 11, comprising FIGS. 11A, 11B and 11C, illustrates acquired patient weight values as presented to the health provider in the system 100 in accordance with the present embodiment. FIG. 11A depicts information 1102 regarding the received weight value is displayed along with a graphic 1104 depicting a visualization of the received weight value. FIG. 11B depicts a graph 1110 of blood pressure values along the y-axis 1112 plotted over time (on the x-axis 1114). An acceptable weight band 1120 in the middle highlights normal weight values for the patient 154. An upper unacceptable weight area 1122 and a lower unacceptable weight area 1124 highlight unacceptable weight values for the patient 154. And upper and lower transition bands 1126, 1128 highlight blood pressure values of concern. Presenting the blood pressure values in this manner allows the healthcare provider 156 to view trends in the weight of the patient 154 and treat it accordingly. The healthcare provider 156 can also quickly tell whether his instructions to the patient 154 are having the correct effect. Also, using the unacceptable weight areas 1122, 1124, the monitoring aspects could be automated with the health care professional 156 only being notified when a concern may have arisen as evidenced by the weight value falling into the unacceptable weight areas 1122, 1124. Referring to FIG. 11C, a table 1130 shows three exemplary problem areas that could be addressed with this type of reminder system with upper and lower limits 1132, 1134, target values 1135, and upper and lower caution areas 1136, 1138 identified by patient 1140 and other identifying information.

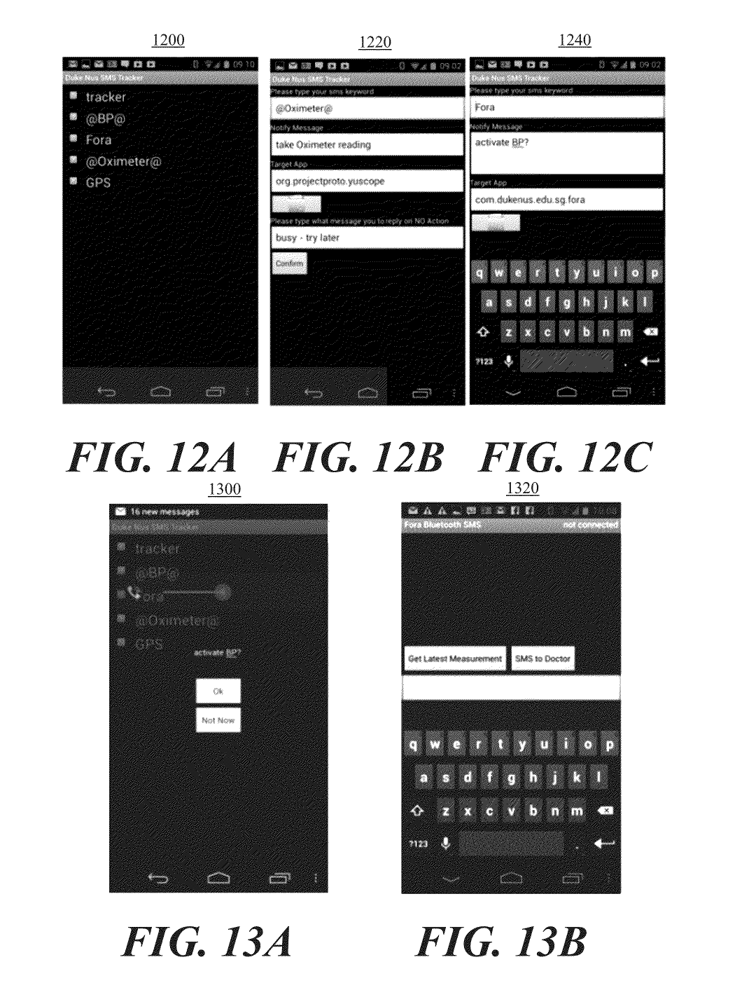

FIG. 12, including FIGS. 12A, 12B and 12C, illustrates communication device screen shots 1200, 1220, 1240 when the communication device 110 is sending remotely triggering messages in the system 100 in accordance with the present embodiment. FIG. 12A depicts a first screen 1200 of an application showing a selection of remote triggering messages to send. FIG. 12B depicts a second screen 1220 showing a remote triggering message for triggering the patient 154 to take oximeter readings and FIG. 12C depicts a third screen 1240 showing a remote triggering message for triggering the patient 154 to take blood pressure readings, both remote triggering messages to send when selection is made from the first screen 1200.

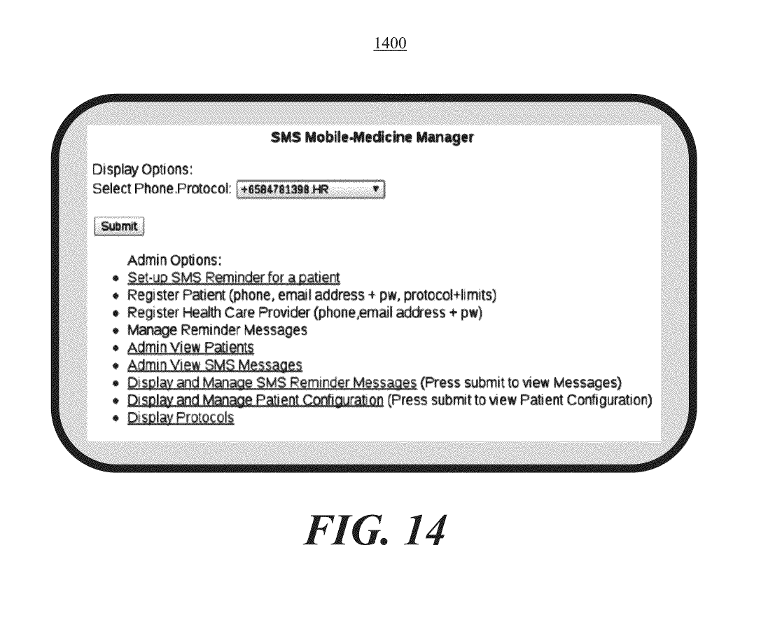

Referring to FIG. 13, including FIGS. 13A and 13B, screen shots 1300, 1320 on the communication device 106 when the communication device 106 is receiving remotely triggering messages in the system 100 in accordance with the present embodiment. A receiving application in the communication device 106 looks for text in a top line of received triggering messages and, upon recognition, a message is generated asking the patient whether to take the measurement or not as seen in the screen shot 1300 (FIG. 13A). If the patient 154 replies YES, the target application is initiated and the screen 1320 (FIG. 13B) is displayed to await further action. If the patient replies NO, then a NO action message is displayed and the measurement is deferred.

FIG. 14 illustrates a screen shot 1400 from a mobile medicine manager program operating in the system 100 in accordance with the present embodiment. The screen shot 1400 shows options for initiating an SMS prompt to the communication device 106 of the patient 154 that triggers a medical application on the communication device for data capture and transfer back to the requesting agent (e.g., the healthcare provide 156). Administrative options include configuring an SMS reminder (1 time or repeating), viewing data and other various administrative tasks.

The healthcare provider 156 has been described alternatively as a medical professional, a nurse or homecare worker, an office or clinic assistant, a hospital or clinic, or a server operating with one or more of these healthcare providers. Those skilled in the art will recognize that non direct health care providers, either public (government health department) or private (e.g., nursing home assistant) may also collect the information by the telephone 110 (FIG. 1A). In addition, the system 100 operating in accordance with the present invention would benefit medical laboratories which, through the reception of diagnostic samples (e.g., blood samples or samples of other bodily fluids), could contact either the health care provider 156 who would initiate appropriate instructions to the patient 154 to provide additional data or contact the patient 154 directly (alone or in addition to the health care provider 156) with instructions for additional testing and or follow-up with the healthcare provider 156. In this manner, the system 100 can enable remote laboratory monitoring of viral outbreaks, genetic testing or immune function monitoring. As testing systems progress, the system 100 operating in accordance with the present embodiment can involve multiple parties within the health care ecosystem to improve remote data intake processes for more efficient patient care leading to more successful patient/doctor encounters either remotely or face-to-face.

While described in regards to provision of healthcare, those skilled in the art will realize that systems and methods in accordance with the present embodiment can be used in many areas where connecting remote workers with other workers is used to assess/adjust a device while maintaining voice consultation between the parties (i.e., any situation which requires concurrent voice communication and data transport). For example, monitoring the status of oil field equipment or providing remote consultation between field workers and experts during device installation/repair could be advantageously handled by implementation of systems and methods similar to those discussed herein (above).

Thus it can be seen that a system of establishing an as needed or continuous active link between two or multiple parties for the purpose of acquiring data and distributing it in geographic and time unconstrained manner to the right parties using existing telephone networks and/or Internet (via WiFi) is provided. The system includes methods, protocols and tools for acquiring data from sensors transferring data from attached (e.g. by Bluetooth or USB) signal transducers, analysing the data, identifying triggering and establishing a data and voice connection to another mobile device (e.g., doctor's or health worker's) or to a fixed device (e.g., server), transporting data between the two mobile devices, providing alerts to relevant parties and providing parallel voice communication and data transport between the two parties or between the source party and a server. While several exemplary embodiments have been presented in the foregoing detailed description, it should be appreciated that a vast number of variations exist, including variations as to the materials, structure and operation of the system.

It should further be appreciated that the exemplary embodiments are only examples, and are not intended to limit the scope, applicability, dimensions, or configuration of the invention in any way. Rather, the foregoing detailed description will provide those skilled in the art with a convenient road map for implementing an exemplary embodiment of the invention, it being understood that various changes may be made in the function and arrangement of elements of the system and method for implementation of the system described in an exemplary embodiment without departing from the scope of the invention as set forth herein, such scope limited only by the claims set out below.

1. A method for remote patient health assessment comprising:
a patient coupling a body parameter measuring device to a patient's cellular phone;
the patient establishing a voice communication path over a cellular network with a health care provider's mobile device by calling the health care provider's mobile device from the patient's cellular phone; and
the patient concurrently establishing a data communication path with the health care provider's mobile device to provide data transport from the body parameter measuring device to the health care provider's mobile device so that the health care provider can talk to the patient while reviewing data received from the body parameter measuring device to provide remote health assessment of the patient.

2. The method in accordance with claim 1 wherein the step of establishing the data communication path comprises the patient's cellular phone discovering an internet protocol address associated with the health care provider's mobile device.

3. The method in accordance with claim 1 wherein the step of establishing the data communication path comprises providing data transport from the body parameter measuring device to the health care provider's mobile device selected from a group of data transport methods comprising streaming data via User Datagram Protocol (UDP), transferring data packets via Transmission Control Protocol (Internet Protocol) (TCP/IP) or episodic text messaging via Short Messaging Service (SMS).

4. The method in accordance with claim 1 wherein the step of establishing the data communication path comprises the patient's cellular phone sending an application triggering SMS to the health care provider's mobile device.

5. The method in accordance with claim 1 wherein the step of establishing the voice communication path comprises the patient calling a server and storing a voice message, the server then contacting the health care provider's mobile device for notification of storing the voice message, and wherein the step of establishing the data communication path comprises the patient's cellular phone providing data to the server for storage therein concurrent with storing the voice message, the data provided to the health care provider's mobile device along with the stored voice message.

6. The method in accordance with claim 1 wherein the step of coupling a body parameter measuring device to a patient's cellular phone comprises the patient coupling the body parameter measuring device to the patient's cellular phone in response to receiving a body parameter measurement reminder.

7. A system for providing health care consultation to remote patients comprising:
a cellular network for providing voice communications and data communications;
a remote patient's cellular phone coupled to the network;
a health care provider's mobile device also coupled to the network; and
a body parameter measuring device coupleable to the remote patient's cellular phone and capable of generating data in response to measuring one or more body parameters,
wherein the remote patient's cellular phone establishes a voice communication path and a data communication path concurrently across the network with the health care provider's mobile device to provide data transport from the body parameter measuring device to the health care provider's mobile device during voice communication between the remote patient's cellular phone and the health care provider's mobile device to enable the health care provider to provide health care consultation to remote patients.

8. The system in accordance with claim 7 wherein the health care provider's mobile device includes a device selected from a medical professional's mobile device, a medical assistant's mobile device, a clinic's mobile device, or a laboratory's mobile device.

9. The system in accordance with claim 7 wherein the network comprises one or more of an internet network, a 3G cellular telephone network and a 4G cellular telephone network.

10. The system in accordance with claim 7 wherein the network comprises a server for storing voice messages and data from the patient's cellular phone for later retrieval by the health care provider's mobile device.

11. The system in accordance with claim 7 wherein the health care provider's mobile device comprises a display for displaying the data from the body parameter measuring device.

12. The system in accordance with claim 7 wherein the body parameter measuring device comprises one or more devices selected from the group of transducer devices including a Bluetooth coupleable device, a USB coupleable device and a near field RF communication coupleable device.

13. The system in accordance with claim 7 wherein the body parameter measuring device comprises one or more devices selected from the group of diagnostic devices including an oximeter, a weighing scale, a spirometer, a thermometer, a stethoscope, an ultrasound, an electrocardiogram (ECG), and an electroencephalogram (EEG).

14. A method for robust communication for status assessment comprising:
coupling a parameter measuring device to a first mobile communication device;
establishing a voice communication path between the first mobile communication device and a second mobile communication device; and
concurrently establishing a data communication path between the first mobile communication device and the second mobile communication device to provide real-time data transport from the parameter measuring device to the second mobile communication device during voice communication therebetween.

15. A method for remote assessment and monitoring comprising:
coupling a parameter measuring device to a first mobile device;
establishing a voice communication path with a central monitoring system from the first mobile device; and
concurrently establishing a data communication path with the central monitoring system to provide data transport from the parameter measuring device to a second mobile device via the central monitoring system.

16. The method in accordance with claim 15 wherein the second mobile device is a healthcare provider's mobile device coupleable to the central monitoring system.

17. The method in accordance with claim 15 wherein the central monitoring system communicates with the first mobile device requesting coupling of the parameter measuring device thereto.

18. The method in accordance with claim 17 wherein the central monitoring system is coupled to a medical laboratory and wherein the step of the central monitoring system communicating with the first mobile device comprises:
the medical laboratory instructing the central monitoring system to request certain data via the first mobile device; and
the central monitoring system communicating with the first mobile device to request coupling of the parameter measuring device thereto to obtain the certain data.
